(19) United States
(12) Patent Application Publication
(10) Pub. No.: US 2012/0284322 A1
(43) Pub. Date: Nov. 8, 2012

(54) Using Geographic Location Data of a Mobile Device by an Application Executing Remotely on a Server

(75) Inventors: Lee Laborczfalvi, Wollstonecraft (AU); Anil Roychoudhry, Woodcroft (AU); Per Magnus Therning, Giteburg (SE); Adam Marano, Parkland, FL (US); Andrew Borzycki, Killara (AU)

(73) Assignee: Citrix Systems, Inc, Ft. Lauderdale, FL (US)

(21) Appl. No.: 13/444,969

(22) Filed: Apr. 12, 2012

Related U.S. Application Data
(60) Provisional application No. 61/474,695, filed on Apr. 12, 2011.

(51) Int. Cl. G06F 15/16

(52) U.S. Cl. 709/202

(57) ABSTRACT

An application executing on a remote virtualization server provides output data for display on a mobile computing device based on geographic location information received from the mobile computing device. For example, a remote virtualization server may transmit a request for geographic location information indicative of the geographic location of a mobile computing device. The remote virtualization server may receive the geographic location information from the mobile computing device and generate output data for display on the mobile computing device based on the geographic location information. The remote virtualization server may then transmit the generated output data to the mobile computing device.

### CROSS-REFERENCE TO RELATED APPLICATION

This application claims the priority benefit of U.S. Patent Application Ser. No. 61/474,695, a provisional patent application filed on Apr. 12, 2011, and entitled “Methods and Systems for Using Geographic Location Data of a Mobile Device by an Application Executing Remotely on a Server,” the disclosure of which is incorporated by reference herein for all purposes.

### FIELD

This disclosure generally relates to computer networks and remote computing, including environments in which a server executes an application on behalf of a client device. More specifically, aspects described herein relate to using data from a sensor from a mobile device by an application executing remotely on a server.

### BACKGROUND

With the increase of mobility in computing devices, there has also been an increase in the need to access and execute applications from mobile devices. Many mobile devices have limited computing and storage capabilities. Mobile devices overcome these limitations by connecting remotely to a server to execute an application on its behalf

Mobile devices such as smart phones and tablet computers have become more sophisticated, often including sensors that capture, store and transmit various types of information. Sensors are capable of capturing or generating data that represents physical phenomena such as temperature and geographic location. Some applications provide application output that relies, in whole or in part, on geographic data. However, it is often the case that the application executing on a server will reflect information from a sensor that is local to the server. Thus, when a user accesses an application executing on a server using a mobile device, the output displayed on the mobile device often does not reflect the geographic location of the mobile device.

### SUMMARY

There is a need for a system to, for example, provide localized (e.g., geographic location) information of a mobile computing device to an application executing remotely on a server. The geographic location information may be, for example, information indicative of the geographic location of the mobile computing device, such as data about the mobile computing device, geographic coordinates (e.g., latitude, longitude, altitude), location accuracy data, user profile information (e.g., a geographic address of the user of the mobile computing device, such as a street address, city, province, postal code, and country information), or any other suitable data that is captured by, generated by, or associated with the mobile computing device. The application executing remotely on the server may use the geographic location information of the mobile computing device to function appropriately on the mobile computing device (e.g., instead of using the geographic location of the remote server). This system may support any sensors that are available on mobile computing devices, such as smart phones or tablets.

In one aspect, described herein, is a method for providing geographic location information of a mobile computing device to an application executing remotely on a server. In one embodiment, the methods and systems may include a mobile device displaying output of an application executing on a server. The output generated by the application executing on the server utilizes geographic location information of the mobile computing device.

In one aspect, described herein, a receiver executing on a server transmits a request to a client agent executing on a mobile device for geographic location information of the mobile device. A user session executing on the server receives the geographic location information of the mobile computing device via a geographic location oriented virtual channel. An application executing in the user session of the server uses the geographic location information of the mobile computing device. The application generates output data using the geographic location information of the mobile computing device. The receiver transmits the output data generated by the application to the client agent for display on the mobile computing device.

In some embodiments, the user session authorizes the application to use the geographic location information of the mobile computing device responsive to a policy. For example, a policy engine executing on the server may access a policy stored on the server in a policy bank for use in determining whether to authorize the application to use the geographic location information of the mobile computing device. In some embodiments, the receiver may receive the geographic location information of the mobile computing device responsive to a change in the geographic location of the mobile device. In further embodiments, the receiver may receive the geographic location information of the mobile computing device when the change in the geographic location of the mobile computing device exceeds a predetermined distance threshold from the previous geographic location of the mobile device.

In some embodiments, a second application executing in the user session uses the geographic location information of the mobile device. In some embodiments, the receiver may receive the geographic location of the mobile computing device periodically responsive to a policy specifying a predetermined length of time. In some embodiments, the receiver logs use of the geographic location information by the application in an event log. In some embodiments, the receiver distributes the geographic location data of the mobile device upon receiving updates from the client agent.

In another aspect, described herein, is a method for displaying, on a mobile device, output of an application executing on a server using geographic location information of the mobile device. In one embodiment, the receiver executing on a server transmits a request to a client agent executing on a mobile device for geographic location information of the mobile device. A user session executing on the server receives the geographic location information of the mobile device via a location oriented virtual channel. An application executing in the user session uses the geographic location information of the mobile device. The application executing in the user session connects to a second application executing in a second user session. The second application uses the geographic location information of the mobile device received from the client agent. The second application transmits output data generated using the geographic location information of the mobile device to the application. The application generates output data using the geographic location information of the mobile device and the output data received from the second application. The receiver transmits to the client agent the output data generated by the application using the geographic location information of the mobile device.

This summary is not intended to identify critical or essential features of the disclosures herein, but instead merely summarizes certain features and variations thereof The details of various embodiments of the methods and systems described herein are set forth in the accompanying drawings and the description below.

### BRIEF DESCRIPTION OF THE DRAWINGS

The following figures depict certain illustrative embodiments of the methods and systems described herein, in which like reference numerals refer to similar elements. These depicted embodiments are to be understood as illustrative of the disclosed methods and systems by way of example and not by way of limitation.

FIG. 1A illustrates an embodiment of a network environment that provides remote access to computing devices that can execute application programs.

FIG. 1B and FIG. 1C illustrate block diagrams that depict embodiments of computing devices.

FIG. 2A illustrates a block diagram depicting one embodiment of a system for using geographic location data of a mobile device by an application executing on a server.

FIG. 2B illustrates a block diagram depicting one embodiment of an architecture of a platform supporting providing geographic location of a mobile device to an application executing on a server.

FIG. 2C illustrates a block diagram depicting one embodiment of an architecture of a platform supporting providing geographic location of a mobile device to an application executing on a server.

FIG. 2D illustrates a block diagram depicting one embodiment of an architecture of a platform supporting providing geographic location of a mobile device to an application executing on a server.

FIG. 3 illustrates a process flow for providing geographic location data of a mobile device to an application executing on a server.

### DETAILED DESCRIPTION

For purposes of reading the description of the various embodiments below, the following descriptions of the sections of the specification and their respective contents may be helpful:
Section A describes a non-limiting illustrative network environment and computing environment which may be useful for practicing embodiments described herein;
Section B describes non-limiting illustrative embodiments of systems for providing geographic location data of a mobile device to an application executing on a server; and
Section C describes non-limiting illustrative embodiments of methods for providing geographic location data of a mobile device to an application executing on a server.

Section A: Network and Computing Environment

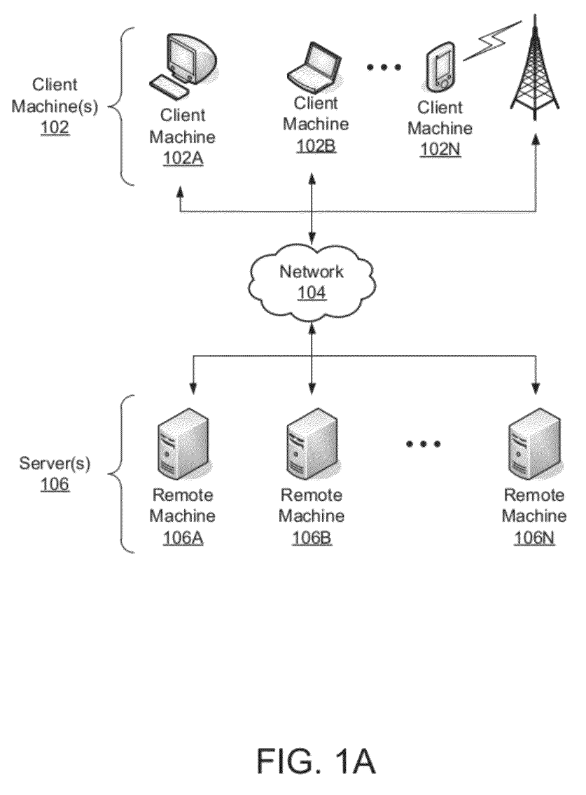

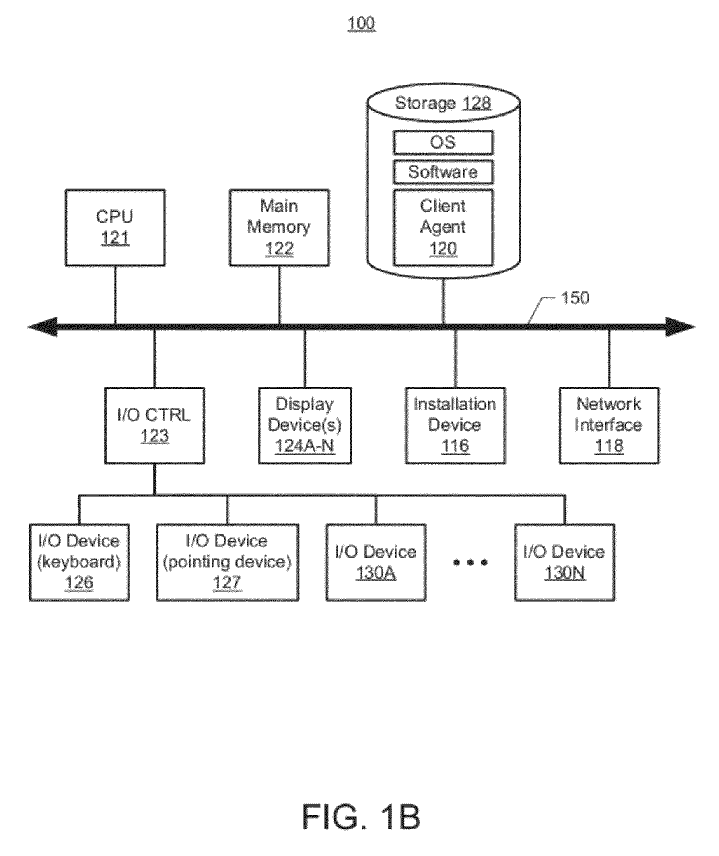

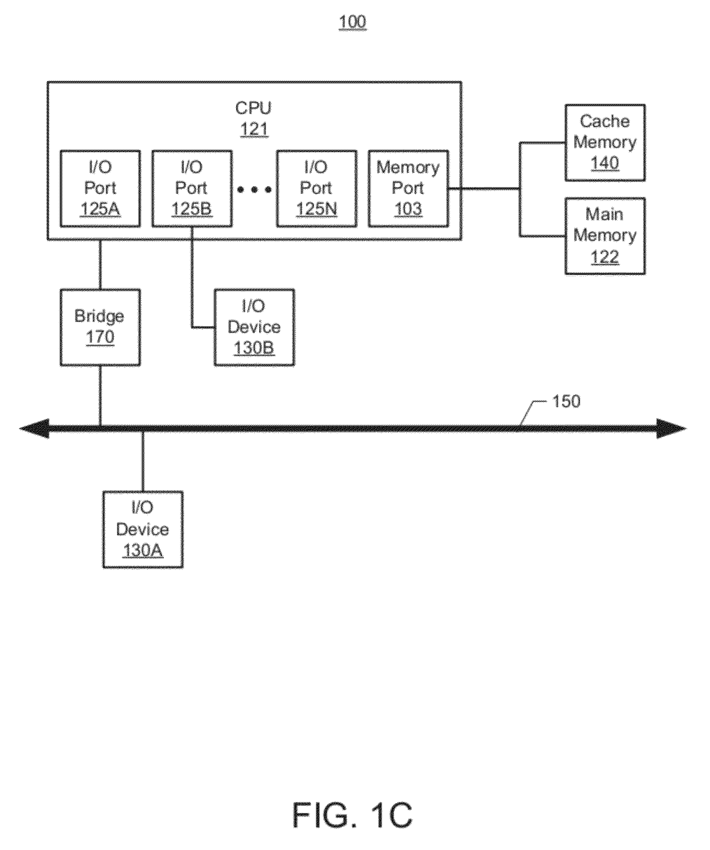

FIG. 1A illustrates one embodiment of a computing environment 101 that includes one or more client machines 102A-102N (generally referred to herein as “client machine(s) 102”) that are in communication with one or more remote machines 106A-106N (generally referred to herein as “server(s) 106”). Installed in between the client machine(s) 102 and server(s) 106 is a network 104.

In one embodiment, the computing environment 101 can include an appliance installed between the server(s) 106 and client machine(s) 102. This appliance can manage client/server connections, and in some cases can load balance client connections amongst a plurality of backend servers.

The client machine(s) 102 can, in some embodiments, be referred to as a single client machine 102 or a single group of client machines 102, while server(s) 106 may be referred to as a single server 106 or a single group of servers 106. In one embodiment a single client machine 102 communicates with more than one server 106, while in another embodiment a single server 106 communicates with more than one client machine 102. In yet another embodiment, a single client machine 102 communicates with a single server 106.

A client machine 102 can, in some embodiments, be referenced by any one of the following terms: client machine(s) 102; client(s); client computer(s); client device(s); client computing device(s); local machine; remote machine; client node(s); endpoint(s); endpoint node(s); or a second machine. The server 106, in some embodiments, may be referenced by any one of the following terms: server(s), local machine; remote machine; server farm(s), host computing device(s), or a first machine(s).

In one embodiment, the client machine 102 can be a virtual machine 102C. In some embodiments, the virtual machine 102C can be managed by a hypervisor, a virtual machine manager (VMM), or any other suitable hardware virtualization technique.

The client machine 102 can in some embodiments execute, operate or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions. Still other embodiments include a client device 102 that displays application output generated by an application remotely executing on a server 106 or other remotely located machine. In these embodiments, the client device 102 can display the application output in an application window, a browser, or other output window. In one embodiment, the application may be a desktop, while in other embodiments the application may be an application that generates a desktop.

The server 106, in some embodiments, executes a remote presentation client or other client or program that uses a thin-client or remote-display protocol to capture display output generated by an application executing on a server 106 and transmits the application display output to a remote client 102. Illustrative examples of thin-client or remote-display protocols include: the Independent Computing Architecture (ICA) protocol manufactured by Citrix Systems, Inc. of Ft. Lauderdale, Fla.; and the Remote Desktop Protocol (RDP) manufactured by the Microsoft Corporation of Redmond, Washington.

The computing environment can include more than one server 106A-106N such that the servers 106A-106N are logically grouped together into a server farm 106. The server farm 106 can include servers 106 that are geographically dispersed and logically grouped together in a server farm 106, or servers 106 that are located proximate to each other and logically grouped together in a server farm 106. Geographically dispersed servers 106A-106N within a server farm 106 can, in some embodiments, communicate using a wide area network (WAN), a metropolitan area network (MAN), or a local area network (LAN), where different geographic regions can be characterized as: different continents; different regions of a continent; different countries; different states; different cities; different campuses; different rooms; or any combination of the preceding geographical locations. In some embodiments the server farm 106 may be administered as a single entity, while in other embodiments the server farm 106 can include multiple server farms 106.

In some embodiments, a server farm 106 can include servers 106 that execute a substantially similar type of operating system platform. In other embodiments, the server farm 106 can include a first group of servers 106 that execute a first type of operating system platform, and a second group of servers 106 that execute a second type of operating system platform. The server farm 106, in other embodiments, can include servers 106 that execute different types of operating system platforms.

The server 106, in some embodiments, can be any server type. In other embodiments, the server 106 can be any of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 106 executing an active directory; or a server 106 executing an application acceleration program that provides firewall functionality, application functionality, or load balancing functionality. In some embodiments, a server 106 may be a RADIUS server that includes a remote authentication dial-in user service. Some embodiments include a first server 106A that receives requests from a client machine 102, forwards the request to a second server 106B, and responds to the request generated by the client machine 102 with a response from the second server 106B. The first server 106A can acquire an enumeration of applications available to the client machine 102 and well as address information associated with an application server 106 hosting an application identified within the enumeration of applications. The first server 106A can then present a response to the client's request using a web interface, and communicate directly with the client 102 to provide the client 102 with access to an identified application.

The server 106 can, in some embodiments, execute any one of the following applications: a thin-client application using a thin-client protocol to transmit application display data to a client; or a remote display presentation application. Another embodiment includes a server 106 that is an application server such as: an email server that provides email services; a web or Internet server; a desktop sharing server; a collaboration server; or any other type of application server. Still other embodiments include a server 106 that executes a hosted server application, such as a remote meeting or desktop sharing application.

Client machines 102 can, in some embodiments, be a client node that seeks access to resources provided by a server 106. In other embodiments, the server 106 may provide clients 102 or client nodes with access to hosted resources. The server 106, in some embodiments, functions as a master node such that it communicates with one or more clients 102 or servers 106. In some embodiments, the master node can identify and provide address information associated with a server 106 hosting a requested application, to one or more clients 102 or servers 106. In still other embodiments, the master node can be a server farm 106, a client 102, a cluster of client nodes 102, or an appliance.

One or more clients 102 and/or one or more servers 106 can transmit data over a network 104 installed between machines and appliances within the computing environment 101. The network 104 can comprise one or more sub-networks, and can be installed between any combination of the clients 102, servers 106, computing machines and appliances included within the computing environment 101. In some embodiments, the network 104 can be: a local-area network (LAN); a metropolitan area network (MAN); a wide area network (WAN); a primary network 104 comprised of multiple sub-networks 104 located between the client machines 102 and the servers 106; a primary public network 104 with a private sub-network 104; a primary private network 104 with a public sub-network 104; or a primary private network 104 with a private sub-network 104. Still further embodiments include a network 104 that can be any of the following network types: a point to point network; a broadcast network; a telecommunications network; a data communication network; a computer network; an Asynchronous Transfer Mode (ATM) network; a Synchronous Optical Network (SONET) network; a Synchronous Digital Hierarchy (SDH) network; a wireless network; a wireline network; or a network 104 that includes a wireless link where the wireless link can be an infrared channel or satellite band. The network topology of the network 104 can differ within different embodiments. Possible network topologies include: a bus network topology; a star network topology; a ring network topology; a repeater-based network topology; or a tiered-star network topology. Additional embodiments may include a network 104 of mobile telephone networks that use a protocol to communicate among mobile devices, where the protocol can be any one of the following: Advanced Mobile Phone System (AMPS); Time Division Multiple Access (TDMA); Code Division Multiple Access (CDMA); Global System for Mobile Communications (GSM); General Packet Radio Service (GPRS); Universal Mobile Telecommunications System (UMTS); Evolution-Data Optimized (EV-DO); Long Term Evolution (LTE); or any other protocol able to transmit data among mobile devices like 802.11, Bluetooth, and Near Field Communication.

Illustrated in FIG. 1B is an embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a central processing unit 121; a main memory 122; storage memory 128; an input/output (I/O) controller 123; display devices 124A-124N; an installation device 116; and a network interface 118. In one embodiment, the storage memory 128 includes: an operating system, software routines, and a client agent 120. The I/O controller 123, in some embodiments, is further connected to a key board 126, and a pointing device 127. Other embodiments may include an I/O controller 123 connected to more than one input/output device 130A-130N.

FIG. 1C illustrates one embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a bridge 170, and a first I/O device 130A. In another embodiment, the bridge 170 is in further communication with the main central processing unit 121, where the central processing unit 121 can further communicate with a second I/O device 130B, a main memory 122, and a cache memory 140. Included within the central processing unit 121, are I/O ports 125A-N, a memory port 103, and a main processor 121.

Embodiments of the computing machine 100 can include a central processing unit 121 characterized by any one of the following component configurations: logic circuits that respond to and process instructions fetched from the main memory unit 122; a microprocessor unit, a microprocessor, a microcontroller, a central processing unit with a single processing core, a central processing unit with two processing cores, a central processing unit with more than one processing core, a programmable logic device, or any other suitable combination of logical circuits.

While FIG. 1C illustrates a computing device 100 that includes a single central processing unit 121, in some embodiments the computing device 100 can include one or more processing units 121. In these embodiments, the computing device 100 may store and execute firmware or other executable instructions that, when executed, direct the one or more processing units 121 to simultaneously execute instructions or to simultaneously execute instructions on a single piece of data. In other embodiments, the computing device 100 may store and execute firmware or other executable instructions that, when executed, direct the one or more processing units to each execute a section of a group of instructions. For example, each processing unit 121 may be instructed to execute a portion of a program or a particular module within a program.

In some embodiments, the processing unit 121 can include one or more processing cores. For example, the processing unit 121 may have two cores, four cores, eight cores, etc. In one embodiment, the processing unit 121 may comprise one or more parallel processing cores. The processing cores of the processing unit 121 may in some embodiments access available memory as a global address space, or in other embodiments, memory within the computing device 100 can be segmented and assigned to a particular core within the processing unit 121. In one embodiment, the one or more processing cores or processors in the computing device 100 can each access local memory. In still another embodiment, memory within the computing device 100 can be shared amongst one or more processors or processing cores, while other memory can be accessed by particular processors or subsets of processors. In embodiments where the computing device 100 includes more than one processing unit, the multiple processing units can be included in a single integrated circuit (IC). These multiple processors, in some embodiments, can be linked together by an internal high speed bus, which may be referred to as an element interconnect bus.

In embodiments where the computing device 100 includes one or more processing units 121, or a processing unit 121 including one or more processing cores, the processors can execute a single instruction simultaneously on multiple pieces of data (SIMD), or in other embodiments can execute multiple instructions simultaneously on multiple pieces of data (MIMD). In some embodiments, the computing device 100 can include any number of SIMD and MIMD processors.

The computing device 100, in some embodiments, can include a graphics processor or a graphics-processing unit. The graphics processing unit can include any combination of software and hardware, and can further input graphics data and graphics instructions, render a graphic from the inputted data and instructions, and output the rendered graphic. In some embodiments, the graphics processing unit can be included within the processing unit 121. In other embodiments, the computing device 100 can include one or more processing units 121, where at least one processing unit 121 is dedicated to processing and rendering graphics.

One embodiment of the computing machine 100 includes a central processing unit 121 that communicates with cache memory 140 via a secondary bus also known as a backside bus, while another embodiment of the computing machine 100 includes a central processing unit 121 that communicates with cache memory via the system bus 150. The local system bus 150 can, in some embodiments, also be used by the central processing unit to communicate with more than one type of I/O device 130A-130N. In some embodiments, the local system bus 150 can be any one of the following types of buses: a Video Electronics Standards Association Local (VL) bus; an Industry Standard Architecture (ISA) bus; an Extended ISA (EISA) bus; a MicroChannel Architecture (MCA) bus; a Peripheral Component Interconnect (PCI) bus; a PCI-Extended (PCI-X) bus; a PCI-Express (PCIe) bus; or an Accelerated Graphics Port (AGP) bus. Other embodiments of the computing machine 100 include an I/O device 130A-130N that is a video display 124 that communicates with the central processing unit 121. Still other versions of the computing machine 100 include a processor 121 connected to an I/O device 130A-130N via any suitable connection, such as: HyperTransport, Rapid I/O, or InfiniBand. Further embodiments of the computing machine 100 include a processor 121 that communicates with one I/O device 130A using a local interconnect bus and a second I/O device 130B using a direct connection.

The computing device 100, in some embodiments, includes a main memory unit 122 and cache memory 140. The cache memory 140 and main memory unit 122 may, and in some embodiments can be any one of the following types of memory: Static Random Access Memory (SRAM), Burst SRAM or SynchBurst SRAM (BSRAM); Dynamic Random Access Memory (DRAM); Fast Page Mode DRAM (FPM DRAM); Enhanced DRAM (EDRAM), Extended Data Output RAM (EDO RAM); Extended Data Output DRAM (EDO DRAM); Burst EDO DRAM (BEDO DRAM); synchronous DRAM (SDRAM); Joint Electron Devices Engineering Council (JEDEC) SRAM; PC100 SDRAM; Double Data Rate SDRAM (DDR SDRAM); Enhanced SDRAM (ESDRAM); SyncLink DRAM (SLDRAM); Ferroelectric RAM (FRAM); memristor based memory; or any other type of memory. Further embodiments include a central processing unit 121 that can access the main memory 122 via: a system bus 150; a memory port 103; or any other connection, bus or port that allows the processor 121 to access memory 122.

One embodiment of the computing device 100 provides support for any one of the following installation devices 116: a CD-ROM drive, a CD-R/RW drive, a DVD-ROM drive, tape drives of various formats, a universal serial bus (USB) device, Secure Digital card, Preboot Execution Environment (PXE) firmware, a bootable medium, a bootable CD, a hard-drive or any other device suitable for installing applications or software. Applications can in some embodiments include a client agent 120, or any portion of a client agent 120. The computing device 100 may further include a storage device 128 that can be either one or more hard disk drives, or one or more redundant arrays of independent disks; where the storage device is configured to store an operating system, software, programs applications, or at least a portion of the client agent 120. A further embodiment of the computing device 100 includes an installation device 116 that is used as the storage device 128.

The computing device 100 may further include a network interface 118 to interface to a LAN, WAN or the Internet through a variety of connections including, but not limited to, standard telephone lines, LAN or WAN links (e.g., 802.11, T1, T3, 56 kb, X.25), broadband connections (e.g., Integrated Services Digital Network (ISDN), Frame Relay, ATM, Gigabit Ethernet, Ethernet-over-SONET), wireless connections, or some combination of any or all of the above. Connections can also be established using a variety of communication protocols (e.g., TCP/IP, Ethernet, Attached Resource Computer Network (ARCNET), SONET, SDH, Fiber Distributed Data Interface (FDDI), RS232, RS485, IEEE 802.11, IEEE 802.11a/b/g/n, CDMA, GSM, Wi-Fi, WiMax and direct asynchronous connections). One version of the computing device 100 includes a network interface 118 able to communicate with additional computing devices via any type and/or form of gateway or tunneling protocol such as Secure Socket Layer (SSL) or Transport Layer Security (TLS). Versions of the network interface 118 can comprise any one of: a built-in network adapter; a network interface card; a Personal Computer Memory Card International Association (PCMCIA) network card; a card bus network adapter; a wireless network adapter; a USB network adapter; a modem; or any other device suitable for interfacing the computing device 100 to a network capable of communicating and performing the methods and systems described herein.

Embodiments of the computing device 100 include any one of the following I/O devices 130A-130N: a keyboard 126; a pointing device 127; mice; trackpads; an optical pen; trackballs; microphones; drawing tablets; video displays; speakers; inkjet printers; laser printers; and dye-sublimation printers; or any other input/output device able to perform the methods and systems described herein. An I/O controller 123 may in some embodiments connect to multiple I/O devices 103A-130N to control the one or more I/O devices. Some embodiments of the I/O devices 130A-130N may be configured to provide storage or an installation medium 116, while others may provide a USB interface for receiving USB storage devices. Still other embodiments include an I/O device 130 that may be a bridge between the system bus 150 and an external communication bus, such as: a USB bus; an RS-232 serial connection; a Small Computer System Interface (SCSI) bus; an IEEE 1394 bus; an Ethernet bus; a Gigabit Ethernet bus; an ATM bus; a High Performance Parallel Interface (HIPPI) bus; a Super HIPPI bus; a SerialPlus bus; a Scalable Coherent Interface (SCI) bus; a FibreChannel bus; or a Serial Attached SCSI (SAS) bus.

In some embodiments, the computing machine 100 can connect to multiple display devices 124A-124N, in other embodiments the computing device 100 can connect to a single display device 124, while in still other embodiments the computing device 100 connects to display devices 124A-124N that are the same type or form of display, or to display devices that are different types or forms. Embodiments of the display devices 124A-124N can be supported and enabled by the following: one or multiple I/O devices 130A-130N; the I/O controller 123; a combination of I/O device(s) 130A-130N and the I/O controller 123; any combination of hardware and software able to support a display device 124A-124N; any type and/or form of video adapter, video card, driver, and/or library to interface, communicate, connect or otherwise use the display devices 124A-124N. The computing device 100 may in some embodiments be configured to use one or multiple display devices 124A-124N. These configurations may include: having multiple connectors to interface to multiple display devices 124A-124N; having multiple video adapters, with each video adapter connected to one or more of the display devices 124A-124N; having an operating system configured to support multiple displays 124A-124N; using circuits and software included within the computing device 100 to connect to and use multiple display devices 124A-124N; and executing software on the main computing device 100 and multiple secondary computing devices to enable the main computing device 100 to use a secondary computing device's display as a display device 124A-124N for the main computing device 100. Still other embodiments of the computing device 100 may include multiple display devices 124A-124N provided by multiple secondary computing devices and connected to the main computing device 100 via a network.

In some embodiments, the computing machine 100 can execute any operating system, while in other embodiments the computing machine 100 can execute any of the following operating systems: any embedded operating system; any real-time operating system; any remote operating system; any operating systems for mobile computing devices; or any other operating system. In still another embodiment, the computing machine 100 can execute multiple operating systems. For example, the computing machine 100 can execute a virtualization platform that can execute or manage a virtual machine executing a first operating system, while the computing machine 100 executes a second operating system different from the first operating system.

The computing machine 100 can be embodied in any one of the following computing devices: a computing workstation; a desktop computer; a laptop or notebook computer; a server; a handheld computer; a mobile telephone; a portable telecommunication device; a media playing device; a gaming system; a mobile computing device; a netbook; a digital audio player or any other type and/or form of computing, telecommunications or media device that is capable of communication and that has sufficient processor power and memory capacity to perform the methods and systems described herein. In other embodiments the computing machine 100 can be a mobile device such as any one of the following mobile devices: a cellular telephone or personal digital assistant (PDA); a smart phone; a handheld computing device; any computing device that has different processors, operating systems, and input devices consistent with the device; or any other mobile computing device capable of performing the methods and systems described herein. In one embodiment, the computing device 100 may be a digital audio player which functions as both a portable media player and as a mass storage device. In some embodiments, the computing device 100 may have different processors, operating systems, and input devices consistent with the device.

In some embodiments, the computing device 100 comprises a combination of devices, such as a mobile phone combined with a digital audio player or portable media player. In one of these embodiments, the computing device 100 is a combination digital audio player and mobile phone. In another of these embodiments, the computing device 100 is a smartphone. In another of these embodiments, the computing device 100 is a tablet computer.

Section B: Systems for Providing Geographic Location of a Mobile Device to an Application Executing Remotely on a Server

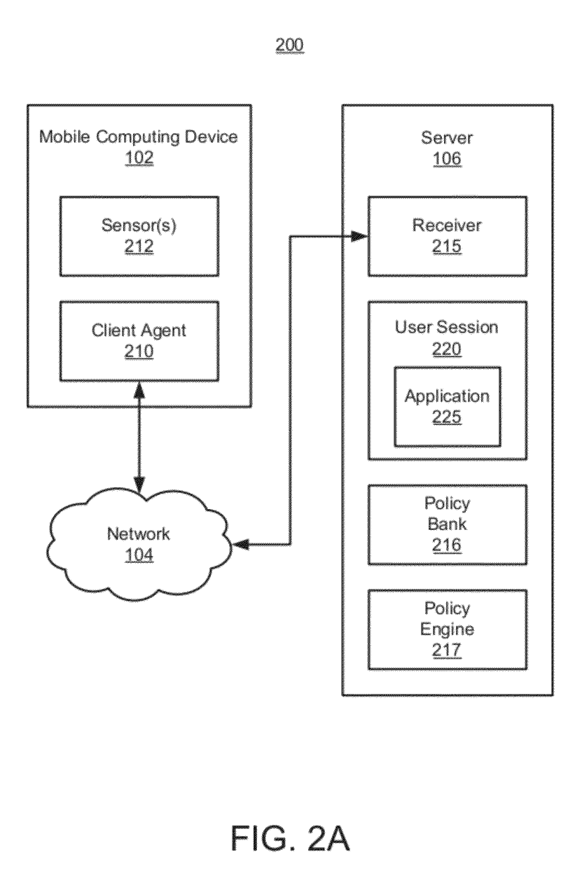

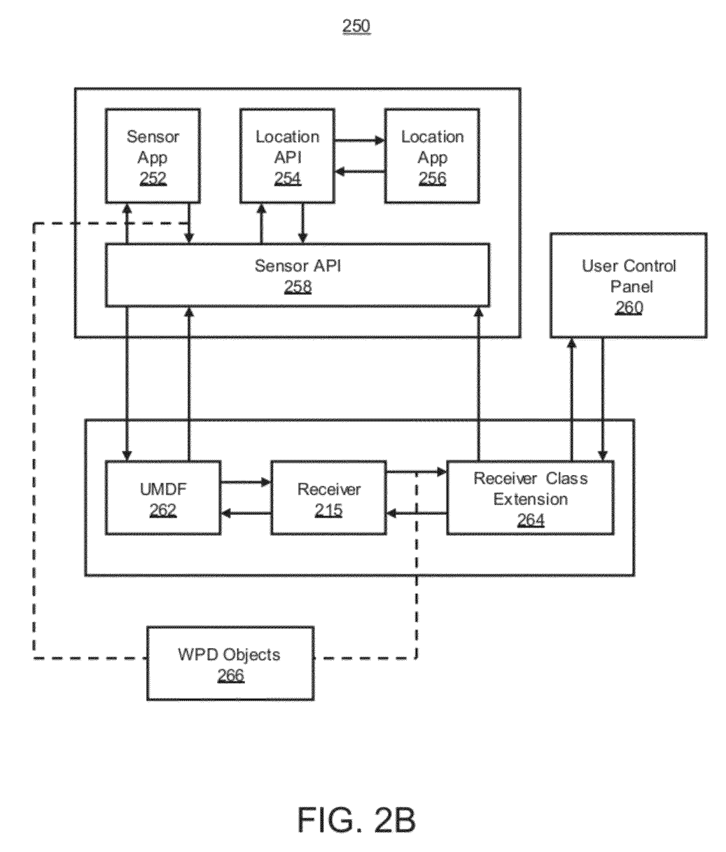

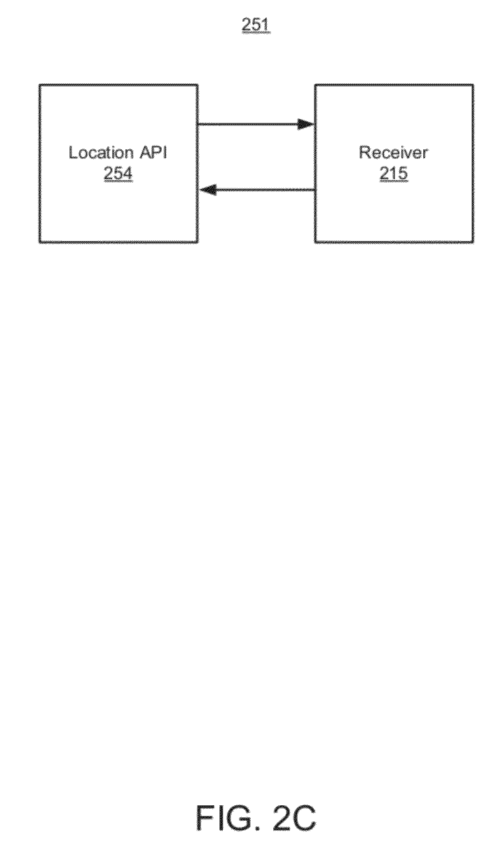

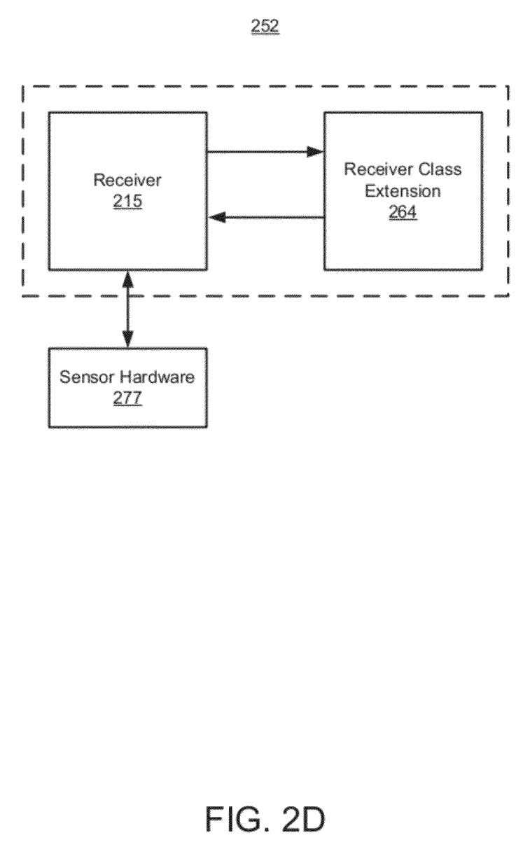

Referring now to FIG. 2A, a block diagram depicts one embodiment of a system 200 for providing geographic location information of a mobile computing device 102 to an application 225 executing remotely on one or more servers 106. In one embodiment, the mobile computing device 102 is a client 102 as described above in connection with FIGS. 1A-1C. Mobile computing device 102 may communicate with one or more servers 106 using any suitable communications link or protocol. A client agent 210 may execute on the mobile computing device 102. A receiver 215 may execute on the server 106. The receiver 215 may communicate with a user session 220 which may also execute on the server 106. An application 225 may execute remotely in the user session 220 on the server 106.

The mobile computing device 102 may contain one or more sensors 212. In some embodiments, one or more sensors 212 may include hardware devices and logical sensors which can also provide information through emulation of sensor functionality in software or firmware. A single hardware device, such as a mobile computing device 102, may contain multiple sensors 212. Sensors 212 may measure any number of physical phenomena, such as temperature, acceleration in two dimensions, acceleration in three dimensions, illumination, physical location, or other similarly measurable events or entities.

In certain implementations, the geographic location information may be determined by processing information received from or associated with the mobile computing device, such as Global Positioning System (GPS) information, cellular tower triangulation information, wireless signal strength, and time of arrival of a wireless signal. For example, one or more sensors 212 may include a geographic location sensor. A geographic location sensor may include, for example, a geographic positioning system (GPS) receiver, an IP resolver that provides geographic location information based on an Internet address, a mobile phone tower triangulator that determines geographic location information based on nearby towers, or static providers, such as a Wi-Fi network location provider that reads geographic location information from the connected wireless network hub. In some embodiments, the geographic location information from the mobile device 102 may be transmitted to the server 106 using the NMEA 0183 protocol for GPS devices.

The mobile computing device 102 comprises a client agent 210. The client agent 210 may include any type or form of hardware and/or combination of hardware and software. For example, the client agent 210 may include any application, program, library, script, process, task thread or any type and form of executable instructions that executes on a client computing device 102. The client agent 210 may connect to one or more servers 106 in the system 200 over a presentation layer protocol or other suitable network protocol. The client agent 210 executing on the mobile computing device 102, in some embodiments, receives data from one or more sensors 212 or other similar hardware or application of the mobile computing device 102. In some embodiments, the data may comprise data about the mobile computing device 102, such as geographic location information indicative of the geographic location of the mobile computing device 102. Geographic location information may include, for example, GPS data, geographic coordinates, location accuracy data, user profile information (e.g., a geographic address of the user of the mobile computing device), or any other suitable data that is captured by, generated by, or associated with the mobile computing device. In some embodiments, the data may comprise any combination of data about or received by the mobile computing device 102.

In some embodiments, the client agent 210 initiates a connection with a server 106 of the system 200. The server 106 may be any type of server or computing device described herein. For example, server 106 may be a virtualization server implemented as a logical server executing on one or more computing devices using a single instance or multiple instances. In some embodiments, the server 106 may comprise one or more servers or devices as described herein. A receiver 215 executing on the server 106 may comprise any type or form of hardware and/or combination of hardware and software. The receiver 215 may include any application, program, library, script, process, task thread or any type and form of executable instructions that executes on a computing device. The mobile computing device 102 may connect to the receiver 215 executing on the server 106 over a network 104 shown in FIG. 1A using any network protocol or any network protocol as described herein. In some embodiments, the receiver 215 communicates with the client agent 210 over the established connection to transmit and receive data. The receiver 215 may send requests to the client agent 210 requesting data, such as geographic location information, from the mobile computing device 102 and receive the requested information from the client agent 210. In some embodiments, the receiver 215 may transmit and receive data from the mobile computing device 102 using a geographic location oriented virtual channel of the remote protocol. In some embodiments, the receiver 215 may transmit and receive data from the mobile computing device 102 using a different virtual channel of the network protocol. In some embodiments, the virtual channel may be terminated on the host side by the receiver 215. The receiver makes the geographic location information received via the virtual channel available to the sensor API 258 shown in FIG. 2B.

The virtual channel from the mobile client device 102 to the server 106 may include information about the mobile computing device 102 and geographic location information including location accuracy information. The client agent 210 may include a virtual driver as the endpoint for the geographic location oriented virtual channel. The virtual driver may periodically update the server with geographic location information from the client agent 210. In some embodiments, optimizations may be implemented where the mobile device 210 does not use GPS functionality or other sensors until required or triggered to, in some instances, mitigate the increased power consumption caused by the use of such sensors.

The application 225 executing remotely on the server 106 may receive data received by the receiver 215 from the client in numerous ways. In one embodiment, the application 225 may receive data synchronously by requesting a particular property or data field. In other embodiments, the application 225 may receive the data asynchronously by subscribing to an event that is raised by the receiver 215.

The receiver 215 communicates with the user session 220 executing on the server 106 and transmits the received data from the mobile computing device 102, making the received data available for use by the application 225. The application 225 may comprise any type or form of hardware and/or combination of hardware and software. The application 225 may include, for example, any application, program, library, script, process, task thread or any type and form of executable instructions that executes on a computing device. The user of the mobile computing device 102 may initiate the application 225. In other embodiments, the application 225 may be executing when the mobile computing device connects to the server 106 over the established connection. The application 225 uses the received data from the receiver 215 to generate output to be transmitted to the mobile computing device to be displayed on the mobile computing device 102 to the user.

In some embodiments, the server 106 may include a policy bank 216. The policy bank 216 may be, for example, a storage device or database storing one or more policies used to determine and authorize access by the mobile computing device 102 to the server 106, use of data received from the client agent 210 by the application 225, or perform any other suitable task. In some embodiments, a policy may be used to configure the client agent 210 or the receiver 215.

In some embodiments, a policy engine, such as policy engine 217, executing on a device may interpret, evaluate, and/or execute policies with respect to functions of the device. For example, the policy engine 217 may execute on the server 106 and interpret and execute a number of policies directing other actions and modules of the server 106 including, without limitation, access to data by the application 225 or access to the server 106 by a particular user, mobile computing device 102, or type of mobile computing device. Policies may be stored in any manner on a device, such as in the policy bank 216 of the server 106.

The policy engine 217 may comprise any type or form of hardware and/or combination of hardware and software. The policy engine 217 may include any application, program, library, script, process, task thread or any type and form of executable instructions that executes on a computing device. The policy engine 217 may include, for example, an intelligent statistical engine or other programmable application(s). In one embodiment, the policy engine 217 may provide a configuration mechanism to allow a user to identify, specify, define or configure a policy. The policy engine 217, in some embodiments, may also have access to memory to support data structures such as lookup tables or hash tables to enable user-selected policy decisions. In other embodiments, the policy engine 217 may comprise any logic, rules, functions or operations to determine and provide access, control and management of objects, data or content being used by the server 106 in addition to access, control and management of data and access to the server 106 or any other function or operation performed by the server 106 or applications executing on the server 106.

In some embodiments, the policy engine 217 may provide a configuration mechanism to allow a user to identify, specify, define or configure policies directing behavior of any other components or functionality of a server. In other embodiments, the policy engine 217 may check, evaluate, implement, or otherwise act in response to any configured policies, and may also direct the operation of one or more server functions in response to a policy.

In some embodiments, a policy may be compiled before it is executed on a device. In other embodiments, a policy may be interpreted at runtime. In some embodiments, the policies may be stored in a database, table, or other data structure on the server 106, such as in policy bank 216. In some embodiments, the policies may be stored on a different computing device 106 and accessed by over a network.

A policy may comprise an expression, rule or action. In some embodiments, the policies are pre-determined at time of manufacture. In some embodiments, the policies can be created, modified, or deleted by an administrator or user. In some embodiments, policies are created, modified, or deleted responsive to other existing policies or responsive to certain actions by the user.

In some embodiments, responsive to a policy, the client agent 210 may prompt the user for permission to enable a location sensor. Because a location sensor can reveal sensitive information, location sensors may not be enabled by default. In some embodiments, the client agent 210 may request the user's permission to enable a location sensor, disable a location sensor or open the Control Panel 260 shown in FIG. 2B for more options (e.g., by the location API 254 communicating directly with the receiver 215).

If no location sensors are installed and no default location has been provided in the Control Panel 260 shown in FIG. 2B, in one embodiment, the receiver 215 may request geographic location information for mobile device 102 by asking a user to enter a default geographic location. The user may also elect not to enter a default location.

In some embodiments, geographic location information available on the server 106 may be pushed to the mobile computing device 102. In some embodiments, the geographic location information may not be the geographic location information of the mobile computing device 102 that connects to the server 106.

In some embodiments, the mobile computing device 102 establishes a connection with a receiver 215 executing on a server 106. The server 106 identifies the mobile device 102. In some embodiments, the server 106 identifies the mobile device 102 by using a pre-determined policy. In some embodiments, the policy is set by an administrator. In other embodiments, the server 106 identifies the mobile device 102 by recognizing the mobile device belongs to an identified group. The group may be determined responsive to a policy, using identifying information about the mobile device 102 or the user. The group may also be manually identified by an administrator or joined by the user. In some instances, a group may be useful because the system may be able to apply identified policies to the entire group rather than the same policies to multiple individual devices.

Once the mobile device 102 is connected to the server 106 and the server 106 recognizes or identifies the mobile device 102, the receiver 215 transmits geographic location information to the client agent 210 executing on the mobile device 102. The client agent 210 then communicates the received geographic location information to an application executing locally on the mobile device 102. In an illustrative example, a fleet routing application executes on the server 106. The user of the mobile computing device 102 connects to the server 106 and, using a client agent 210 of the fleet routing application, communicates with the fleet routing application 225 executing on the server 106 to display the geographic location of the next delivery. The receiver 215 receives the request from the client agent 210 and queries the data available to the application 225 to determine the geographic location of the next appointment. The receiver 215 transmits the identified geographic location information requested to the client agent 210. In one embodiment, the client agent 210 stores the received data on the mobile computing device 102 so that applications executing on the mobile computing device 102 may retrieve the data received from the server 106. In some embodiments, the client agent 210 directly transmits the received data to the application requesting the information. In some embodiments, the client agent 210 directly transmits the received information to a navigation application executing on the mobile computing device 102.

In some embodiments, the application 225 cannot directly receive geographic location information from the mobile computing device 102, despite its ability to use geographic location information. In some embodiments, the server 106 hosting the application 225 provides a service that will respond to requests for geographic location data from the application 225. The service requests the client agent 210 to provide its geographic location information. The configuration of the application 225 is modified so that when an attempt is made to retrieve geographic location information, the application 225 uses the service executing locally on the server 106 instead of a location service of the application 225 unaware of the mobile computing device 102. In some embodiments, the application 225 cannot be configured to use the service executing locally on the server 106. Then, the requests of the application 225 for geographic location information are re-directed to an external location service to the service executing locally on the server 106. When the service receives the request for the geographic location information, the service transmits a request to the client agent 210 and receives geographic location information from the client agent 210. Thus, the service is able to supply the information to the application 225 despite the application 225′s inability to receive external geographic location information from the receiver 215.

Now referring to FIG. 2B, a block diagram depicts one embodiment of an architecture 250 of a platform supporting providing geographic location of a mobile device to an application 225 executing remotely on a server 106. The Location Application Programming Interface (API) 254 provides data to location aware applications, such as the application 225. The location data is presented to the Location API 254 by the receiver 215 which works with the mobile computing device 102 and the receiver class extension 264. The receiver class extension 264 is a data object implemented using the User Mode Driver Framework (UMDF) 262. The receiver 215 is also implemented using the UMDF 262. As depicted by the dashed line in FIG. 2B, sensor device drivers may be implemented using the Windows Portable Devices (WPD) 266 driver model, based on the UMDF 262.

The Sensor API 258 provides a set of methods, properties, and events to work with connected sensors and sensor data. Sensor data may include, for example, data corresponding to, or derived from, a geographic location sensor, an accelerometer, a thermometer, or any other sensor capable of measuring or capturing data indicative of its surroundings. The Location API 254 provides a set of programming objects. These objects include scripting objects for working with location information. The Control Panel 260 lets computer administrators enable sensors, including location sensors, for individual users. Sensor device drivers may be implemented by using the Windows Portable Devices (WPD) driver model, such as a driver model based on the User Mode Driver Framework (UMDF).

In some embodiments, the development of a user mode sensor driver using the UMDF allows for a solution that will best solve the customer problem and allow the highest level of application and system compatibility. In one embodiment, the Location API 254 is hooked into the system described herein. In some embodiments, Location API logging comprises all applications accessing or using the data received from a sensor by a mobile computing device 102 or by other suitable techniques.

The Sensor API 258 enables developers to create sensor-based programs by using a set of component object model (COM) interfaces. The Sensor API 258 defines interfaces to perform common sensor programming tasks that include managing sensors by category, type, or ID, managing sensor events, working with individual sensors and sensor collections, and working with sensor data.

In some embodiments, the Location API 254, built on the Sensor API 258, provides a way to retrieve data about geographic location while protecting user privacy. The Location API 254 provides its functionality through a set of COM interfaces. These interfaces can be used in scripting languages, such as Jscript, or by COM programmers through the C++ programming language.

The Control Panel 260 permits computer administrators to enable or disable sensors system-wide or for each user. Because some sensors can expose sensitive data, this user interface gives administrators control over whether programs have access to each sensor for each user. Users can also view sensor properties and change the sensor description that appears in the user interface.

As shown in FIG. 2C, a block diagram depicts one embodiment of an architecture 251 of a platform supporting providing geographic location of a mobile device to an application 225 executing remotely on a server 106. In particular, the Location API 254 may communicate directly with the receiver 215, thus bypassing the Sensor API 258, UMDF 262, Receiver Class Extension 264, User Control Panel 260, and WPD Objects 266 shown in FIG. 2B.

Now referring to FIG. 2D, a block diagram depicts one embodiment of an architecture 252 of a platform supporting providing geographic location of a mobile device to an application 225 executing remotely on a server 106. The receiver 215 works with the sensor hardware 277 to provide the location based data. In some embodiments, the sensor hardware 277 is part of the mobile computing device 102. In other embodiments, the sensor hardware may be a device that is associated with a mobile computing device 102, through such means as a serial port or Bluetooth. The receiver class extension 264 provides a simple set of interfaces that allow components of the application 225 and the location platform, such as the Sensor API 258, Location API 254, and Control Panel 260, to discover and enumerate connected sensors. The receiver class extension 264 also helps to ensure that user privacy is well protected because the receiver class extension 264 enforces appropriate access control restrictions for sensors that handle personal information. In some embodiments, the receiver class extension 264 also provides a standard way to retrieve data from the driver and to raise event notifications through the API layers.

Section C: Methods for Providing Geographic Location of a Mobile Device to an Application Executing Remotely on a Server

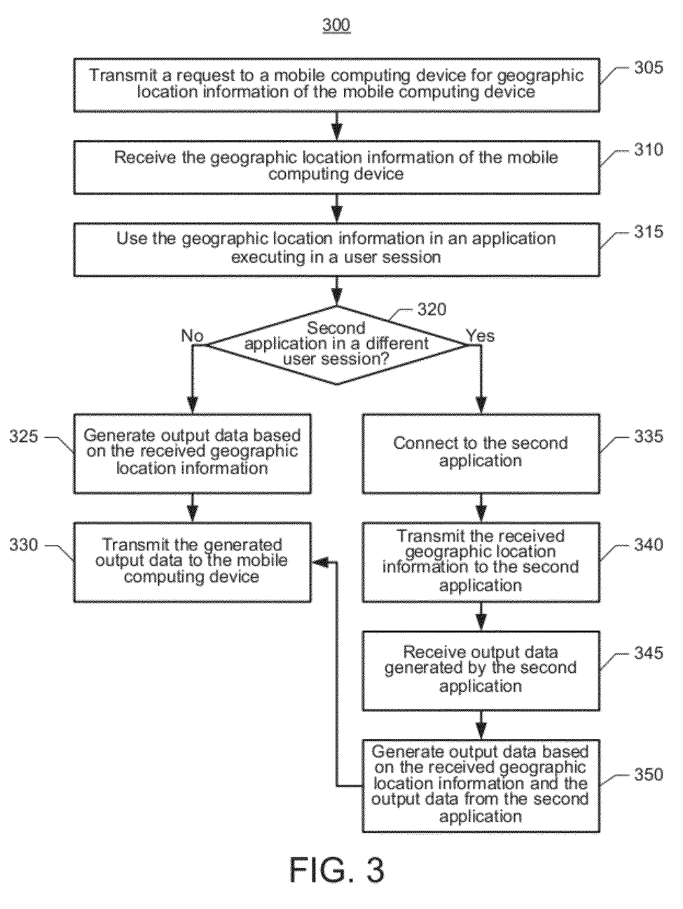

Now referring to FIG. 3, an illustrative process flow 300 for displaying output of an application executing on a server using geographic location information of a mobile computing device is shown.

At step 305, a receiver (e.g., receiver 215) executing on a server (e.g., server 106) transmits a request for geographic location information of a mobile computing device (e.g., mobile computing device 102) to a client agent (e.g., client agent 210) executing on the mobile computing device. In some embodiments, a user session (e.g., user session 220), responsive to a policy (e.g., a policy stored in policy bank 216), authorizes an application (e.g., application 225) to use the geographic location information of the mobile computing device. In some embodiments, the receiver executing on the server may communicate with the client agent executing on the mobile computing device using an established remote network protocol. In other embodiments, the receiver executing on the server may communicate with the client agent executing on the mobile computing device using other forms of communication, such as Short Message Service (SMS) messaging or another suitable protocol. The client agent executing on the mobile computing device may acknowledge the request and initiate a presentation layer protocol connection. In some embodiments, the receiver executing on the server may transmit a request for sensor data of the mobile computing device to the client agent executing on the mobile computing device.

At step 310, the user session executing on the server receives the geographic location information of the mobile device, such as geographic positioning system data, location accuracy data and any other suitable data or combination thereof In some embodiments, the geographic location information may be captured by a sensor or other similar hardware (e.g., sensor hardware 277) of the mobile computing device. For example, geographic location information may be captured or collected by the mobile computing device using GPS. In some embodiments, geographic location information may be obtained through other mechanisms, such as IP address information, wireless access point information or other suitable identifying information for use in location extrapolation or extraction. For example, the IP address information or wireless access point information may be transmitted to a service, such a web service or local application of the mobile computing device, to determine the geographic location data. Once the mobile computing device receives the geographic location information from the service, the mobile computing device may transmit the geographic location to the receiver executing on the server.

In some embodiments, the receiver may receive the geographic location information of the mobile computing device responsive to a change in the geographic location of the mobile computing device. The geographic location information of the mobile computing device may be transmitted by the client agent executing on the mobile computing device to the receiver executing on the server when a change in the geographic location of the mobile computing device exceeds a predetermined distance threshold from the previous geographic location of the mobile computing device. The receiver executing on the server may receive the geographic location information of the mobile device at any suitable frequency responsive to a policy specifying a predetermined length of time. In some embodiments, the receiver executing on the server may distribute the geographic location information of the mobile computing device upon receiving updates from the client agent executing on the mobile computing device.

At step 315, the application executing in the user session of the server uses the geographic location information of the mobile computing device. In some embodiments, geographic location information may be received from multiple sources, such as from a sensor local to the server and from a sensor executing on the mobile computing device. In some embodiments, the geographic location information provided by the local sensor of the server may be replaced by the geographic location information provided by the mobile computing device. In some embodiments, the user session may assign a priority value to the type or location of the sensor that provided the geographic location information and, when geographic location information is received from multiple sources, the geographic location information received from the sensor with the highest priority will be used by the application. In some embodiments, the priority may be assigned responsive to a policy. For example, the policy may assign priority based on the relative location of the sensor to the application executing remotely on the server, the user, the type of data sensor, the age of the sensor, the model of the sensor, the manufacturer of the sensor, or any other suitable information. In some embodiments, the priority value may be pre-determined at the time of manufacture. In some embodiments, the priority value may be assigned by a user or system administrator. In some embodiments, the priority value may be determined using any suitable combination of factors.

In some embodiments, a second application executing in the user session may use the geographic location information of the mobile computing device. In some embodiments, the second application may receive the geographic location information or sensor data from the application executing remotely on the server. In other embodiments, the second application may receive the geographic location information or sensor data from the user session. In some embodiments, the second application may receive the geographic location information or sensor data from the receiver.

At step 320, the server determines whether the application needs to communicate or initiate a second application executing in a second user session. In some embodiments, the application may need to initiate a second application in a second user session in order to complete an action or task. In some embodiments, the application executing remotely on a server connects to the second application that is already executing in a second user session to receive data generated by the second application. If the application does not need to communicate or initiate a second application executing in a second user session, process 300 may proceed to step 325. If the application needs to communicate or initiate a second application executing in a second user session, process 300 may proceed to step 335.

At step 325, the application executing remotely on the server generates output using the geographic location information of the mobile computing device. In some embodiments, the receiver logs the use of the geographic location information by the application in an event log. At step 330, the receiver transmits the output generated by the application to the client agent and process 300 may end.

At step 335, the application executing remotely on the server connects to a second application executing in a second user session. At step 340, the application transmits the geographic location information of the mobile computing device to the second application. The second application uses the geographic location information of the mobile computing device to generate output data. The second application transmits the output data generated by the second application to the application (i.e., the application according to steps 305-315). At step 345, the application receives the output data generated by the second application. At step 350, the application generates output data using the geographic location information and output data received from the second application. At step 330, the receiver transmits the output data generated by the application executing remotely on the server to the client agent executing on the mobile computing device for display on the mobile computing device. In some embodiments, the receiver logs the use of the geographic location information by the application in an event log. After step 350, process 300 may proceed to step 330.

While certain embodiments have been described and shown in the accompanying drawings, it is to be understood that such embodiments are merely illustrative of and not restrictive on the methods and systems described herein. Additionally, it is possible to implement the methods and systems described herein or some of its features in hardware, programmable devices, firmware, software or a combination thereof The methods and systems described herein or parts of the methods and systems described herein may also be embodied in executable instructions stored in a computer-readable storage medium or machine-readable medium such as a magnetic (e.g., hard drive, floppy drive), optical (e.g., compact disk, digital versatile disk, etc.), or semiconductor storage medium (e.g., volatile, non-volatile).

What is claimed is:

1. A method comprising:
receiving, at a user session executing on a virtualization server from a client agent executing on a mobile computing device, geographic location information indicative of a geographic location of the mobile computing device;
generating, in an application executing in the user session, output data for display on the mobile computing device based on the geographic location information; and
transmitting, from the receiver executing on the virtualization server to the client agent executing on the mobile computing device, the generated output data.

2. The method of claim 1, further comprising:
transmitting, from the user session executing on the virtualization server to the client agent executing on the mobile computing device, a request for the geographic location information,
wherein receiving the geographic location information comprises receiving the geographic location information in response to transmitting the request for the geographic location information.

3. The method of claim 1, wherein receiving the geographic location information comprises receiving the geographic location information via a geographic location oriented virtual channel of a remote protocol.

4. The method of claim 1, wherein receiving the geographic location information comprises receiving the geographic location information in response to a change in the geographic location of the mobile computing device.

5. The method of claim 4, wherein receiving the geographic location information comprises receiving the geographic location information in response to a determination that the change in the geographic location of the mobile computing device is greater than a predetermined distance threshold.

6. The method of claim 1, wherein receiving the geographic location information comprises receiving the geographic location information periodically based on a policy specifying a predetermined length of time.

7. The method of claim 1, wherein the geographic location information comprises one or more of data about the mobile computing device, geographic positioning system data, geographic coordinates, location accuracy data, user profile information, and sensor data.

8. The method of claim 1, further comprising:
authorizing the application to use the geographic location information based on a policy.

9. The method of claim 1, wherein the application is a first application, wherein the user session is a first user session, and wherein the output data is first output data, the method further comprising:
transmitting the geographic location information to a second application executing in a second user session; and
receiving second output data generated by the second application,
wherein generating the first output data comprises generating the first output data based on the geographic location information and the second output data.

10. A computing device comprising:
a processor; and
a memory storing instructions that, when executed by the processor, cause the computing device to:
receive, by a virtualization server executing on the computing device, from a client agent executing on a mobile computing device, geographic location information indicative of a geographic location of the mobile computing device;
generate, by an application executing in a user session of the virtualization server, output data for display on the mobile computing device based on the geographic location information; and
transmit, to the client agent executing on the mobile computing device, the generated output data.

11. The computing device of claim 10, wherein the memory further stores instructions that, when executed by the processor, cause the computing device to:
transmit, to the client agent executing on the mobile computing device, a request for the geographic location information; and
receive, from the client agent executing on the mobile computing device, the geographic location information in response to transmitting the request for the geographic location information.

12. The computing device of claim 10, wherein the memory further stores instructions that, when executed by the processor, cause the computing device to:
receive the geographic location information via a geographic location oriented virtual channel of a remote protocol.

13. The computing device of claim 10, wherein the memory further stores instructions that, when executed by the processor, cause the computing device to:
receive the geographic location information in response to a change in the geographic location of the mobile computing device.

14. The computing device of claim 13, wherein the memory further stores instructions that, when executed by the processor, cause the computing device to:
receive the geographic location information in response to a determination that the change in the geographic location of the mobile computing device is greater than a predetermined distance threshold.

15. The computing device of claim 10, wherein the memory further stores instructions that, when executed by the processor, cause the computing device to:
receive the geographic location information periodically based on a policy specifying a predetermined length of time.

16. The computing device of claim 10, wherein the geographic location information comprises one or more of data about the mobile computing device, geographic positioning system data, geographic coordinates, location accuracy data, user profile information, and sensor data.

17. The computing device of claim 10, wherein the memory further stores instructions that, when executed by the processor, cause the computing device to:
authorize the application to use the geographic location information based on a policy.

18. The computing device of claim 10, wherein the application is a first application, wherein the user session is a first user session, wherein the output data is first output data, and wherein the memory further stores instructions that, when executed by the processor, cause the computing device to:
transmit the geographic location information to a second application executing in a second user session;
receive second output data generated by the second application; and
generate the first output data based on the geographic location information and the second output data.

19. A non-transitory computer readable storage medium storing computer readable instructions which, when read by a computer, instruct the computer to perform steps comprising:
receiving, at an application executing in a virtualization server, geographic location information indicative of a geographic location of a remote mobile computing device;
generating, in the application executing in the virtualization server, output data for display on the remote mobile computing device based on the geographic location information; and
transmitting the generated output data to the remote mobile computing device.

20. The non-transitory computer readable storage medium of claim 19, wherein the computer readable storage medium stores further computer readable instructions which, when read by the computer, instruct the computer to perform steps comprising:
transmitting a request for the geographic location information to the remote mobile computing device,
wherein receiving the geographic location information comprises receiving the geographic location information in response to transmitting the request for the geographic location information.
